(19) United States
(12) Patent Application Publication
(10) Pub. No.: US 2013/0076562 A1
(43) Pub. Date: Mar. 28, 2013

(54) PRECISE GPS DEVICE AND METHOD USING A WIRELESS AP

(71) Applicants: Sang Uk Lee, Daejeon (KR); Do Seob Ahn, Daejeon (KR); Jae Eun Lee, Seoul (KR)

(72) Inventors: Sang Uk Lee, Daejeon (KR); Do Seob Ahn, Daejeon (KR); Jae Eun Lee, Seoul (KR)

(73) Assignee: ELECTRONICS AND TELECOMMUNICATIONS RESEARCH INSTITUTE, Daejeon (KR)

(21) Appl. No.: 13/701,394

(22) PCT Filed: Jun. 13, 2011
(86) PCT No.: PCT/KR2011/004308

§ 371 Date: Nov. 30, 2012

(30) Foreign Application Priority Data
Jun. 11, 2010 (KR) 10-2010-0055673
Jun. 1, 2011 (KR) 10-2011-0052810

(51) Int. Cl. G01S 19/40; G01S 19/07

(52) U.S. Cl. CPC G01S 19/40; G01S 19/07
USPC 342/357.23

(57) ABSTRACT

In the present invention, a GPS reference station generates and transmits GPS error correction information for each wireless AP and a user terminal recognizes the GPS error correction information to be used for correcting reception information of a user terminal GPS receiver, thereby acquiring precision positioning performance. That is, a precision poisoning system of the present invention includes: a GPS reference station generating navigation correction information for a wireless access point by receiving a first satellites' signal from a GPS satellite with respect to the reference station and transmitting the generated navigation correction information to the wireless access point; a wireless access point receiving the navigation correction information from the GPS reference station and transmitting the received information to a user terminal; and a user terminal receiving a second satellites' signal from the GPS satellite with respect to the user terminal and recognizing the navigation correction information from the wireless access point to generate precise user position information on the basis of the second satellite signal and the navigation correction information.

### TECHNICAL FIELD

The present invention relates to a positioning apparatus and a positioning method, and more particularly, to an apparatus and a method that can perform precision positioning by transmitting GPS error correction information using a wireless AP as a virtual reference station and allowing a user to receive the corresponding information.

This work was supported by the IT R&D program performed as a part of a development project of a satellite navigation ground station system and search and rescue beacon of the Ministry of Knowledge Economy (MKE) [Project Management No. 2007-S-301-03: Technological Development of Satellite Navigation ground Station System and Search and Rescue Beacon].

### BACKGROUND ART

A global positioning system (GPS) is a name for a position detecting system using an artificial satellite or an apparatus thereof, which is developed on the purpose of complementing a navy navigation satellite system which has been used for military in the United States Department of Defense and notifying flying aircrafts and sailing ships of precise positions thereof, to let them to know their current precise positions at any point on earth.

The use of GPS extends to construction machineries, personal laptop computers, cellular phones, etc. in recent years as well as navigation systems for the aircrafts, the ships, and the like due to an advantage in that comparative precise position information can be known only by a simple GPS receiver.

However, in the GPS, until a signal is transmitted from a transmitter of a GPS satellite and thereafter, received by a receiver to acquire a position result value, various error factors (a satellite clock error, a satellite orbit error, an ionosphere delay error, a convector layer error, a multipath error, and the like) are present and a user can acquire an imprecise position result value by the error factors. As a result, various methods for acquiring more precise position information have been developed, and among them, a differential GPS (a relative positioning system, DGPS) has currently come into the spotlight as the most widely used method.

The DGPS is the navigation system in which a reference station of which the position is known calculates an error component included in a pseudo range measurement value using information sent from a current visible navigation satellite and notifies the calculated error component to an adjacent user to thereby enable further improved positioning. In the DGPS, the reference station compares a position calculated by receiving a GPS signal with its own position which is previously measured to calculate positional error correction information by the GPS signal at the corresponding moment and thereafter, transmits the calculated information to the user. At this time, the user reflects the positional error correction information to his/her position calculation to calculate a current precise position.

However, great expenses are required to install the actual reference station to comply with these requirements.

As a method for solving this problem, there is a method to acquire the effect in that the real reference station is positioned next to the general user by providing a virtual reference station at a position close to a general user.

However, a high-performance server is required to support the virtual reference station for each user's requirement in spite of using the virtual reference station. The number of simultaneously supported users is limited depending on the performance of the server.

### DISCLOSURE

### Technical Problem

The present invention is contrived under the above-mentioned technical background. An objective of the present invention is to provide an apparatus and a method in which users of a smartphone, a netbook, and a laptop can efficiently perform precision positioning at a low cost.

Another objective of the present invention is to provide an apparatus and a method that enable precision positioning by using wireless access points (APs) such as WiFi and mobile communication base stations, and the like instead of a virtual reference station.

### Technical Solution

In order to achieve the objectives, in the present invention, a GPS reference station generates GPS error correction information for each wireless AP to transmit the generated GPS error correction information to each wireless AP and a user terminal recognizes the GPS error correction information to be used for correcting reception information of a user terminal GPS receiver, thereby providing precision positioning performance.

That is, a precision positioning system according to an aspect of the present invention includes: a GPS reference station generating navigation correction information for a wireless access point by receiving first satellites' signal from visible GPS satellites with respect to the reference station(hereinafter “first satellites' signal” and transmitting the generated navigation correction information to the wireless access point; a wireless access point receiving the navigation correction information from the GPS reference station and transmitting the received information to a user terminal; and a user terminal receiving second satellites' signal from the GPS satellites with respect to the user terminal(hereinafter “second satellites' signal” and recognizing the navigation correction information from the wireless access point to generate precise user position information on the basis of the second satellites' signal and the navigation correction information.

Herein, the wireless access point may be a WiFi or mobile communication base station.

The GPS reference station may include: a reference station GPS receiver receiving the first satellite signal from the GPS satellite; a communication unit capable of communicating with the wireless access point; and a correction information generating unit generating the navigation correction information by comparing an actually measured position of the wireless access point with the first satellite signal and preferably receives the actually measured position of the wireless access point from the wireless access point or stores the actually measured position in a storage device which is previously provided therein.

Further, the user terminal may include: a GPS receiver receiving the second satellites' signal; a communication unit capable of communicating with the wireless access point; and a position information correcting unit generating precise user position information on the basis of the second satellites' signal and the navigation correction information, and may further include a storage unit storing the navigation correction information.

A precision positioning apparatus according to another aspect of the present invention includes: a GPS receiver receiving a satellite signal from a GPS satellite; a communication unit capable of communicating with a wireless access point; and a positioning information correcting unit receiving navigation correction information for the wireless access point from the wireless access point by communicating with the wireless access point and generating precise position information thereof on the basis of the navigation correction information and the satellite signal.

The precision positioning apparatus may further include a storage unit storing the navigation correction information, the communication unit may communicate with the wireless access point through a WiFi or mobile communication scheme, and the receiver may receive an actually measured position of the wireless access point in addition to the navigation correction information.

A precision positioning method by a precision positioning system including a GPS reference station, a wireless access point, and a user terminal according to yet another aspect of the present invention includes: generating, by the GPS reference station, navigation correction information for a wireless access point by receiving first satellites' signal from a GPS satellite; transmitting, by the GPS reference station, the generated navigation correction information to the wireless access point; receiving, by the user terminal, second satellites' signal from the GPS satellite; receiving, by the user terminal, the navigation correction information from the wireless access point; and generating, by the user terminal, precise user position information on the basis of the second satellite signal and the navigation correction information.

A precision positioning method by a user terminal, which includes a GPS receiver and a wireless communication unit according to still yet another aspect of the present invention includes: receiving first satellites' signal; receiving navigation correction information for the wireless access point from a near wireless access point capable of performing communication by using the wireless communication unit; and generating precise user position information on the basis of the first satellites' signal and the navigation correction information.

### Advantageous Effects

According to the present invention, navigation correction information required for precision positioning is generated by a reference station and received through wireless Internet APs such as WiFi and mobile communication base stations, and the like to process both reception information of a GPS receiver (GNSS chipset) mounted on a user terminal such as a smartphone, a personal navigation device (PND), or the like and information provided from the wireless APs. Accordingly, it is possible to provide positioning information of performance more remarkably improved than positioning information at the time when the GPS receiver of the user terminal processes the positioning information singly.

### DESCRIPTION OF DRAWINGS

FIG. 1 is a diagram schematically showing an overall configuration of a precision positioning system using a wireless AP according to an exemplary embodiment of the present invention.

FIG. 2 is a diagram showing a schematic configuration of a reference station of a precision positioning system using a wireless AP according to an exemplary embodiment of the present invention.

FIG. 3 is a diagram showing a schematic configuration of a receiving apparatus of a precision positioning system using a wireless AP, i.e., a precision positioning apparatus according to an exemplary embodiment of the present invention.

FIG. 4 is a flowchart showing a precision positioning method using a wireless AP according to an exemplary embodiment of the present invention.

### BEST MODE

Advantages and characteristics of the present invention, and methods for achieving them will be apparent with reference to embodiments described below in detail in addition to the accompanying drawings. However, the present invention is not limited to the exemplary embodiments to be described below but may be implemented in various forms. Therefore, the exemplary embodiments are provided to enable those skilled in the art to thoroughly understand the teaching of the present invention and to completely inform the scope of the present invention and the exemplary embodiment is just defined by the scope of the appended claims. Meanwhile, terms used in the specification are used to explain the embodiments and not to limit the present invention. In the specification, a singular type may also be used as a plural type unless stated specifically. “comprises” and/or “comprising” used the specification mentioned constituent members, steps, operations and/or elements do not exclude the existence or addition of one or more other components, steps, operations and/or elements.

Hereinafter, a precision positioning apparatus and a precision positioning method using a wireless AP according to exemplary embodiments of the present invention will be described in detail with reference to the accompanying drawings.

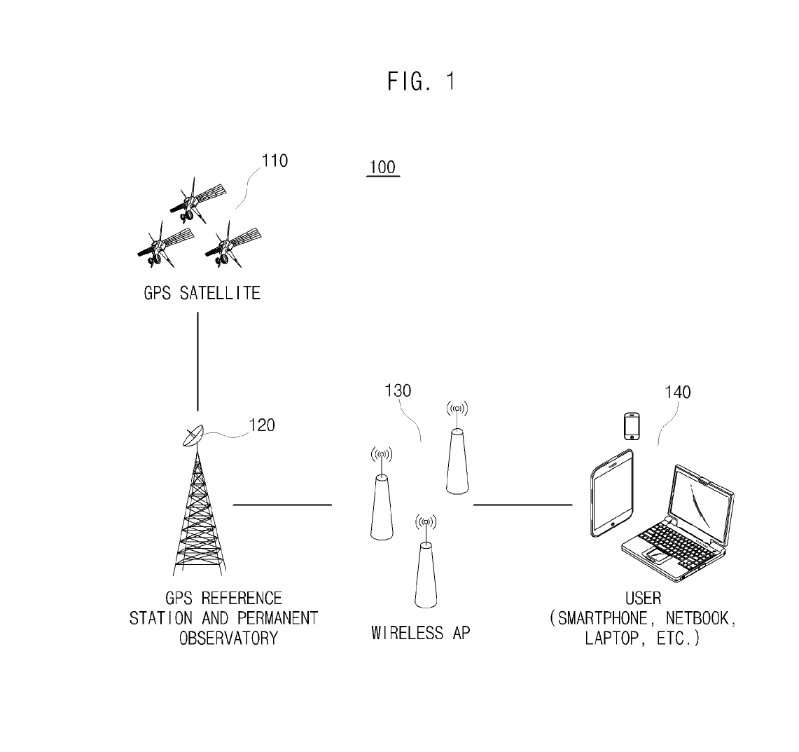

FIG. 1 is a configuration diagram of an entire system including a precision positioning system using a wireless AP according to an exemplary embodiment of the present invention.

A precision positioning system 100 using a wireless AP according to an exemplary embodiment of the present invention includes a GPS satellite 110, a GPS reference station and a permanent observatory 120 receiving data from the GPS satellite 110 to generate navigation correction information and transmitting correction information for the position of each wireless AP (hereinafter, simply referred to as a ‘reference station’), a wireless AP 130 receiving the correction information from the reference station 120 and transmitting the received correction information to a user, and a user terminal 140 automatically recognizing the correction information from the near wireless AP 130.

The user terminal 140 includes all terminals which can be use the Internet, such as a smartphone, a netbook, a laptop, and the like, and since the user terminal 140 is a main agent of precision positioning, the user terminal 140 is also called a precision positioning apparatus.

The GPS satellite 110 continuously broadcasts, at a speed of 50 bps, a navigation message including state information of the satellite, a time and an error of a clock mounted on the satellite, orbit information, an almanac and an ephemeris, a coefficient for error correction, and the like.

The reference station 120 is installed at a point of which the position is precisely measured, receives satellite data by using a reference station GPS receiver 122, and since the precision position of the reference station is known, a true range for the satellite can be calculated. When the calculated true range is subtracted from a measured pseudo range, a common error of each satellite can be acquired. Further, the reference station 120 may generate navigation correction information such as a carrier ambiguity integer in addition to the navigation error information.

In the precision positioning system 100 using the wireless AP according to the exemplary embodiment of the present invention, since the wireless APs 130 such as WiFi and CDMA stations, and the like are used as a virtual reference station, the reference station 120 determines the position of each wireless AP 130 and processes data of a signal received from the GPS satellite 100 to generate the navigation correction information such as the carrier ambiguity integer for the position of each wireless AP 130. To this end, the reference station 120 may receive an actually measured position of each wireless AP 130 from each wireless AP 130 or store the actually measured position in a storage device previously provided in the reference station 120.

The generated correction information is transmitted to each wireless AP 130. Each wireless AP 130 transmits the received correction information to the user terminal 140.

The user terminal 140 recognizes correction information regarding the position of the corresponding wireless AP 130 from the near wireless AP 130 and calculates a precise user position by using the GPS reception information and the correction information of the user terminal 140.

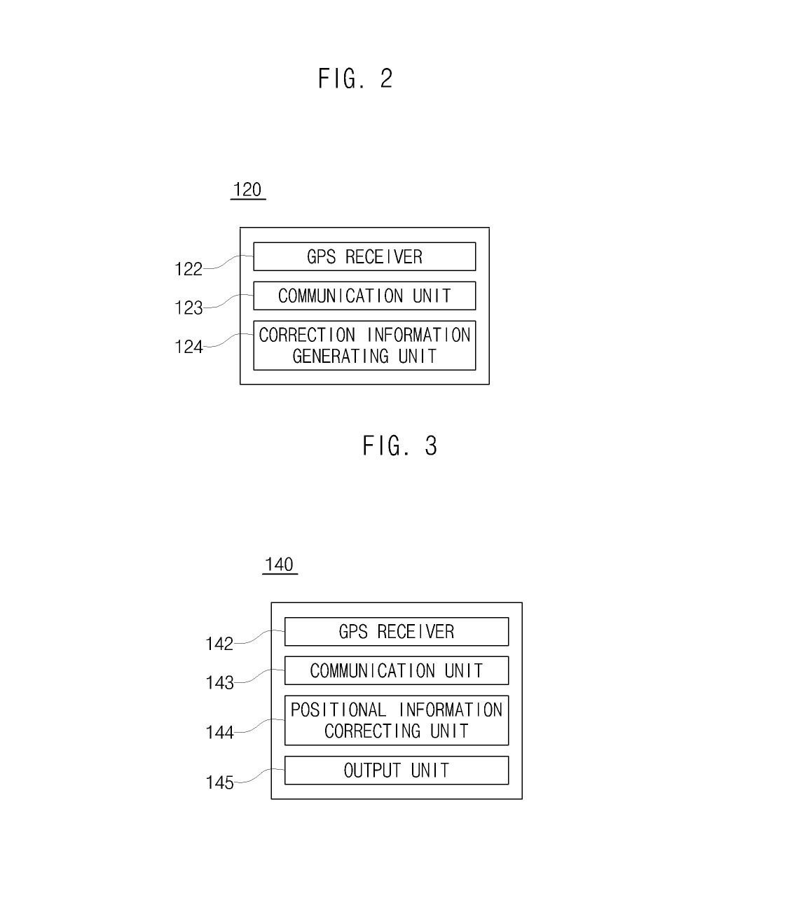

FIG. 2 schematically shows a configuration of the reference station 120 according to an exemplary embodiment of the present invention.

As shown in FIG. 2, the reference station 120 according to the exemplary embodiment of the present invention includes the reference station GPS receiver 122 for permanent observation, a correction information generating unit 123 generating the navigation correction information such as the carrier ambiguity integer on the basis of the signal received through the reference station GPS receiver 122 and the actually measured position of each wireless AP 130, and a communication unit 124 for transferring the generated correction information to each wireless AP 130.

The communication unit 124 is used to communicate with each wireless AP 130 and provides a function to communicate by using schemes such as WiFi, CDMA, and the like.

FIG. 3 shows a configuration of the user terminal 140, i.e., the precision positioning apparatus according to the exemplary embodiment of the present invention.

As shown in FIG. 3, a precision positioning apparatus 140 according to an exemplary embodiment of the present invention includes a user terminal GPS receiver 142 receiving the satellite signal from the GPS satellite 110, a communication unit 143 communicating with the wireless AP 130 in order to receive the navigation correction information from the wireless AP 130, and a position information correcting unit 144 generating precise position information based on the received satellite signal and navigation correction information. Further, the precision positioning apparatus 140 includes an output unit 145 outputting the generated position information to the user.

The communication unit 143 may use different communication methods depending on the types of the precision positioning apparatus 140 and the wireless AP, and for example, the communication unit 143 may communicate with the wireless AP 130 by using the WiFi and CDMA schemes, and the like.

According to the exemplary embodiment of the present invention, as the precision positioning apparatus 140, the terminals which can use the Internet, such as the smartphone, the netbook, the laptop, and the like are used, and the terminals, of course, include the communication unit 143 that can communicate with the wireless AP 130.

As a result, the precision positioning apparatus 140 can perform precision positioning by using both the navigation correction information received from the wireless AP 130 and the GPS receiving function mounted on the precision positioning apparatus 140 itself. Therefore, the precision positioning apparatus 140 can acquire positioning performance more remarkably improved than the general case using only the GPS receiver.

Meanwhile, the precision positioning apparatus 140 according to the exemplary embodiment of the present invention may further include a storage unit (not shown) storing the received navigation correction information. When the precision positioning apparatus 140 stores the received navigation correction information, the stored navigation correction information may be used again for future precision positioning.

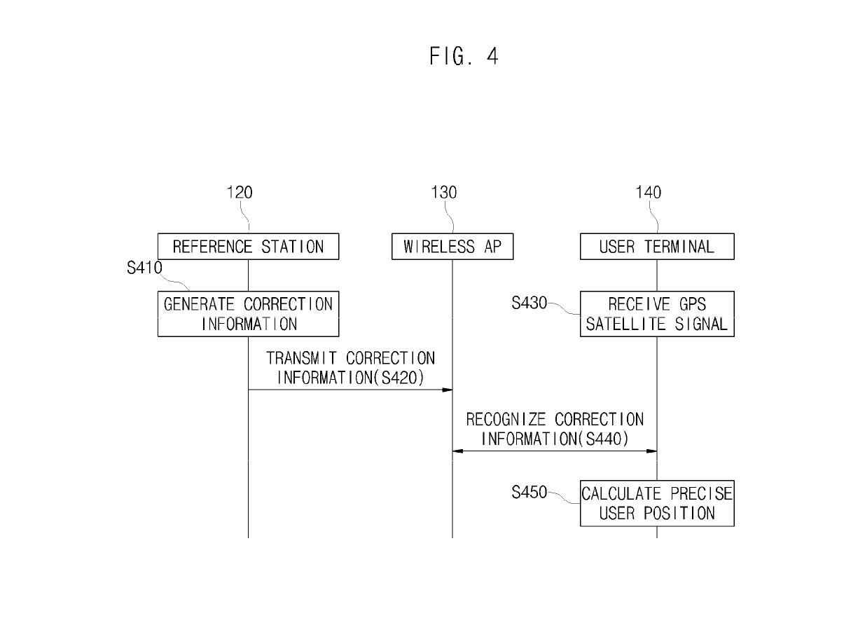

Hereinafter, a precision positioning method using a wireless AP according to an exemplary embodiment of the present invention will be described. FIG. 4 is a flowchart showing a precision positioning method using a wireless AP according to an exemplary embodiment of the present invention.

First, a reference station 120 determines the position of each wireless AP 130 and processes data of a signal received from a GPS satellite 110 to generate navigation error information and navigation correction information for the position of each wireless AP 130 (S410). The generated navigation error information and navigation correction information are transmitted to each wireless AP 130 (S420).

A user terminal that intends to perform precision positioning, i.e., a precision positioning apparatus 140 receives a GPS satellite signal by using a user terminal GPS receiver 142 (S430) and recognizes navigation correction information for the position of the corresponding wireless AP 130 from the near wireless AP 130 (S440).

Next, the user terminal calculates a precise user position by using the received GPS satellite signal and the navigation correction information recognized through the wireless AP 130 (S450).

As described above, precision positioning performance can be acquired by using the navigation correction information received from the wireless AP 130.

Although the present invention has been described on the basis of exemplary embodiments, the present invention is not particularly limited to the exemplary embodiments and it should be understood that various modifications and changes can be made without departing from the spirit and scope of the present invention. Accordingly, the appended claims will include these modification or changes as long as they belong to the gist of the present invention.

1. A precision positioning system, comprising:
a GPS reference station generating navigation correction information for a wireless access point by receiving first satellites' signal from a GPS satellite and transmitting the generated navigation correction information to the wireless access point;
a wireless access point receiving the navigation correction information from the GPS reference station and transmitting the received information to a user terminal; and
a user terminal receiving second satellites' signal from the GPS satellite and recognizing the navigation correction information from the wireless access point to generate precise user position information on the basis of the second satellite signal and the navigation correction information.

2. The system of claim 1, wherein the wireless access point is a WiFi or CDMA base station.

3. The system of claim 1, wherein the GPS reference station includes:
a reference station GPS receiver receiving the first satellite signal from the GPS satellite;
a communication unit capable of communicating with the wireless access point; and
a correction information generating unit generating the navigation correction information by comparing an actually measured position of the wireless access point with the first satellites' signal.

4. The system of claim 3, wherein the GPS reference station receives the actually measured position of the wireless access point from the wireless access point or stores the actually measured position in a storage device which is previously provided therein.

5. The system of claim 1, wherein the user terminal includes:
a GPS receiver receiving the second satellites' signal from the GPS satellite;
a communication unit capable of communicating with the wireless access point; and
a position information correcting unit generating precise user position information on the basis of the second satellite signal and the navigation correction information.

6. The system of claim 5, wherein the user terminal further includes a storage unit storing the navigation correction information.

7. A precision positioning apparatus, comprising:
a GPS receiver receiving a satellite signal from a GPS satellite;
a communication unit capable of communicating with a wireless access point; and
a positioning information correcting unit receiving navigation correction information for the wireless access point from the wireless access point by communicating with the wireless access point and generating precise position information thereof on the basis of the navigation correction information and the satellites' signal.

8. The apparatus of claim 7, further comprising a storage unit storing the navigation correction information.

9. The apparatus of claim 7, wherein the communication unit communicates with the wireless access point through a WiFi or mobile communication scheme.

10. The apparatus of claim 7, wherein the receiver receives an actually measured position of the wireless access point in addition to the navigation correction information.

11. A precision positioning method by a precision positioning system including a GPS reference station, a wireless access point, and a user terminal, the method comprising:
generating, by the GPS reference station, navigation correction information for a wireless access point by receiving first satellites' signal from a GPS satellite;
transmitting, by the GPS reference station, the generated navigation correction information to the wireless access point;
receiving, by the user terminal, second satellites' signal from the GPS satellite;
receiving, by the user terminal, the navigation correction information from the wireless access point; and
generating, by the user terminal, precise user position information on the basis of the second satellite signal and the navigation correction information.

12. The method of claim 11, further comprising storing, by the user terminal, the received navigation correction information.

13. The method of claim 11, wherein the user terminal receives the navigation correction information from the wireless access point, which is a WiFi or mobile communication base station.

14. A precision positioning method by a user terminal, which includes a GPS receiver and a wireless communication unit, the method comprising:
receiving first satellites' signal from a GPS satellite;
receiving navigation correction information for the wireless access point from a near wireless access point capable of performing communication by using the wireless communication unit; and
generating precise user position information on the basis of the first satellite signal and the navigation correction information.

15. The method of claim 14, further comprising storing the received navigation correction information.

16. The method of claim 14, wherein the wireless communication unit is capable of performing communication with a WiFi or mobile communication base station.

17. The method of claim 14, wherein the navigation correction information is generated based on second satellites' signal received by a GPS reference station and transmitted to the wireless access point.
